(19) United States
(12) Patent Application Publication
(10) Pub. No.: US 2005/0275535 A1
(43) Pub. Date: Dec. 15, 2005

(54) Lock core with an alarm

(76) Inventor: Hui-Hua Hsieh, Chung Ho City (TW)

Correspondence Address: Hui-Hua HSIEH, P.O. Box 90, Tainan City, 704, TW

(21) Appl. No.: 10/856,995

(22) Filed: Jun. 1, 2004

(51) Int. Cl. E05B 45/06

(52) U.S. Cl. 340/542; 70/336

(57) ABSTRACT

A lock core with an alarm includes a shell, an inner rotary member, a plurality of locking pin units, an alarm-actuating unit and an alarm-stopping unit. In using, a correct key is inserted in the inner rotary member so the surface of the key can trigger the alarm-actuating unit to let the alarm in a lock sound out. Rotation of the key for a certain angle can rotate the inner rotary member to unlock the lock and also stop the alarm. In case a wrong key is used by a thief to insert in the key hole but impossible to rotate the inner rotary member to unlock the lock, then the alarm will sound out after the preset time (3-5 seconds) in subsequence of insertion of the wrong key, frightening a would-be thief.

### BACKGROUND OF THE INVENTION

1. Field of the Invention

This invention relates to a lock core with an alarm, particularly to one provided with an alarm actuating unit to be pushed up by a correct key inserted in a key hole of an inner rotary body in a shell of the lock core to start an alarm provided in the lock, and an alarm stopping unit to be actuated by the key rotated in the key hole to unlock a deadbolt and also toughing an alarm stopping switch to stop the alarm and to unlock the lock at the same time. Should a would-be thief insert a wrong key in the key hole for attempting to pry open the lock, the alarm will be started to sound out after a set time (3-5 seconds) in sequence of insertion of the wrong key to frighten the thief to run away, so the lock with this lock core with an alarm is extraordinarily effective in anti-theft.

2. Description of the Prior Art

Generally, a common lock has a core structure designed with an objective to make it complicated enough for not to be pried open illegally and easily. But it can only delay the time of being pried open by a thief, not impossible to prevent anti-theft completely.

### SUMMARY OF THE INVENTION

The objective of the present invention is to offer a lock core with an alarm to freak out any one who attempts to pry open the lock with this lock core by sounding an alarm if a wrong key is inserted in the keyhole of the lock, but impossible to be rotated to unlock the deadbolt of the lock.

The feature of the invention is a shell, an inner rotary member, a plurality of locking pin units, an alarm actuating unit, and an alarm-stopping unit. The shell has a chamber and a plurality of transverse holes. The inner rotary member is positioned in a chamber of the shell, having a keyhole and a plurality of transverse holes communicating with the transverse holes and corresponding to the transverse holes of the shell. The inner rotary member further has a projecting member extending rearward and having an annular groove and a recess on its outer surface. The locking pin units are movably received respectively in the transverse holes of the shell and of the inner rotary member. The alarm-actuating unit is positioned in a foremost transverse hole of the shell and of the inner rotary member, consisting of a long pin, a short pin, a spring, an insulating base and a trigger switch. The alarm-stopping unit is positioned in the rearmost hole of the shell and the recess of the inner rotary member, consisting of a pin, a spring, an insulating base and a stopping switch.

### BRIEF DESCRIPTION OF DRAWINGS

This invention will be better understood by referring to the accompanying drawings, wherein:

FIG. 1 is an exploded perspective view of a lock core in the present invention;

FIG. 2 is a perspective view of the lock core in the present invention;

FIG. 3 is a cross-sectional view of the lock core in the present invention, showing it under locked condition;

FIG. 4 is a cross-sectional view of the lock core in the present invention, with a correct key inserted in the lock core; and,

FIG. 5 is a cross-sectional view of the lock core in the present invention, showing it in the unlocked condition with the correct key inserted and rotated for a certain angle.

### DETAILED DESCRIPTION OF THE PREFERRED EMBODIMENT

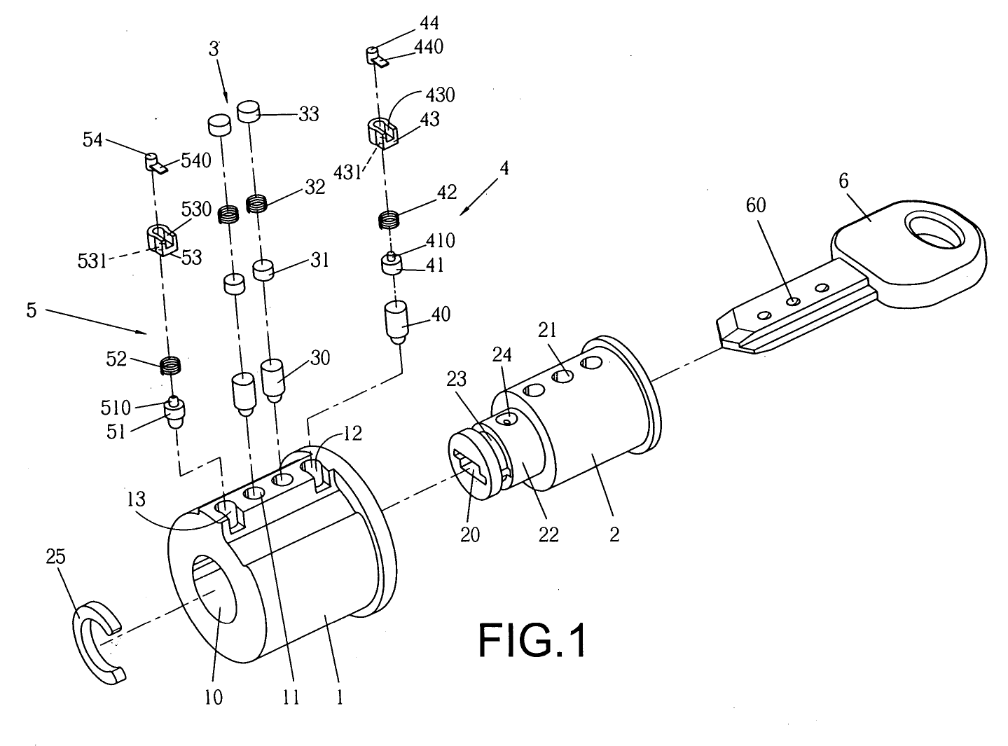

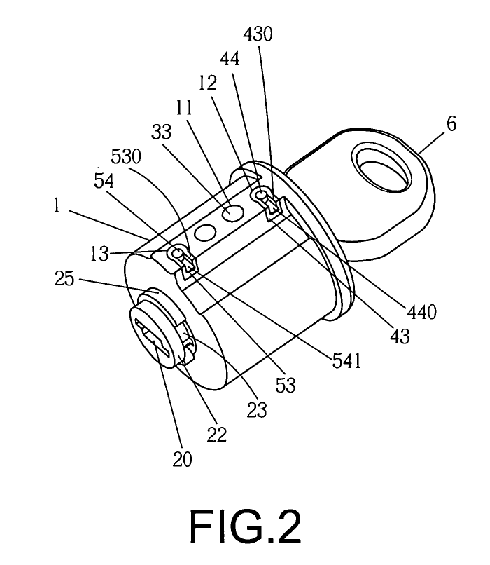

A preferred embodiment of a lock core with an alarm in the present invention, as shown in FIGS. 1, 2 and 3, includes a shell 1, an inner rotary member 2, a plurality of locking pin units 3, an alarm-actuating unit 4, an alarm-stopping unit 5, and a key 6 as main components.

The shell 1 is provided with a chamber 10 formed in the center, a plurality of transverse holes 11 spaced apart in a straight line in the wall of the shell 1 and communicating with the chamber 10, two grooves 12 and 13 respectively formed in an upper end of the foremost one and the rearmost one of the transverse holes 11.

The inner rotary member 2 is received in the chamber 10, having a key hole 20 and a plurality of transverse holes 21 spaced apart in a straight line in its wall and communicating with the key hole 20 and also corresponding to the transverse holes 11 of the shell, a projecting member 22 extending rearward and having an annular groove 23 and a recess 24 formed in an outer surface, and a hook ring 25 engaging on the annular groove 23.

The plurality of locking pin units 3 to be received respectively in the holes 11 and 21 of the shell 1 and the inner rotary member 2 consist respectively of a long pin 30, a short pin 31, a spring 32 and a stopper 33 orderly arranged.

The alarm actuating unit 4 to be received in the foremost hole 11 and 21 of the shell and the inner rotary member 2 consists of a long pin 40, a short pin 41, a spring 42, an insulating base 43 and a trigger switch 44 orderly arranged. The short pin 41 has a stud 410 on an upper end, and the insulating base 43 has a cell 430 opening upward and a hole 431 in its bottom, and the alarm actuating switch 44 provided with a conductive member 440 to be connected with an alarm provided in the lock.

The alarm stopping unit 5 is to be received in the rearmost hole 11 of the shell 1 and in the recess 24 of the rotary member 2, consisting of a pin 51, a spring 52, an insulating base 53 and a stopping switch 54. The pin 51 has a stud 510 on its upper end, the insulating base 53 has a cell 530 opening upward and a hole 531 in its bottom, and the stopping switch 54 has a conductive member 540 to be connected with the alarm in the lock.

The key 6 is to be inserted in the keyhole 20 for unlocking the lock and stopping the alarm at the same time, having a plurality of recesses 60 of mutually different depths spaced apart on a surface of the key 6.

In assembling, referring to FIGS. 1, 2 and 3, firstly, the inner rotary member 2 is placed stably in the chamber 10 of the shell 1, with the projecting member 22 extending in the rear portion of the shell 1, and with the hook ring 25 engaging on the annular groove 23 of the projecting member 22. Then the transverse holes 21 and the recess 24 of the inner rotary member 2 are automatically aligned to the transverse holes 11 of the shell 1, and then the long pins 30, the short pins 31, the springs 32 are orderly inserted in the holes 11 and 21 of the shell 1 and the inner rotary member 2, with the stoppers 33 fixed in the upper ends of the transverse holes 11 of the shell 1, positioning stably the locking pins units 3 in the shell 1 and the inner rotary member 2. Next, the long pin 40, the short pin 41 and the spring 42 of the alarm actuating member 4 are orderly placed in the foremost hole 11 of the shell 1 and the foremost hole 21 of the inner rotary member 2, with the insulating base 43 and the trigger switch 44 are orderly placed in the groove 12 on the foremost transverse holes 11 and 21 of the shell 1 and the inner rotary member 2. Further, the pin 51, the spring 52 of the alarm stopping unit 5 are orderly placed in the rearmost hole 11 of the shell 1, with the pin 51 having its bottom located in the recess 24 of the inner rotary member 2, and with the insulating base 53 and the stopping switch 54 located in the groove 13 on the rearmost hole 11 of the shell 1. The key 6 is to be inserted in the keyhole 20 of the inner rotary member 2 for unlocking the lock and also stopping the alarm. Thus the lock core of the present invention is finished in assembly.

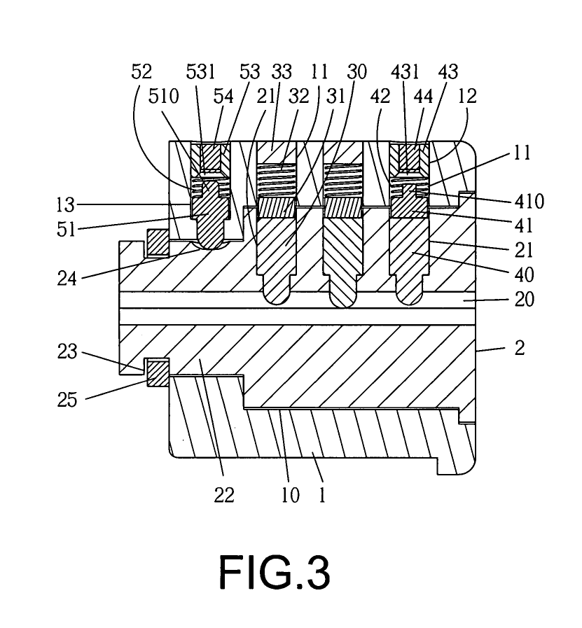

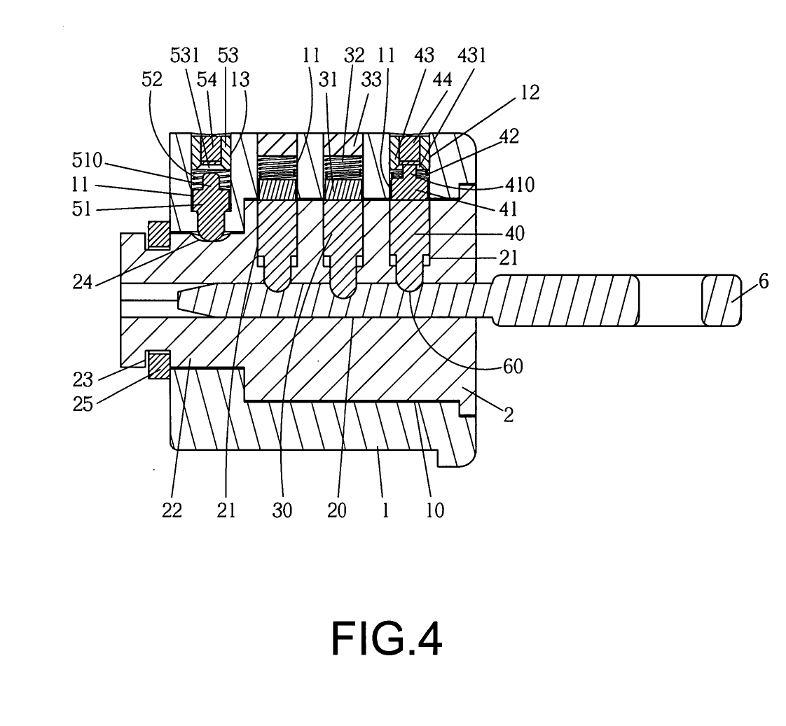

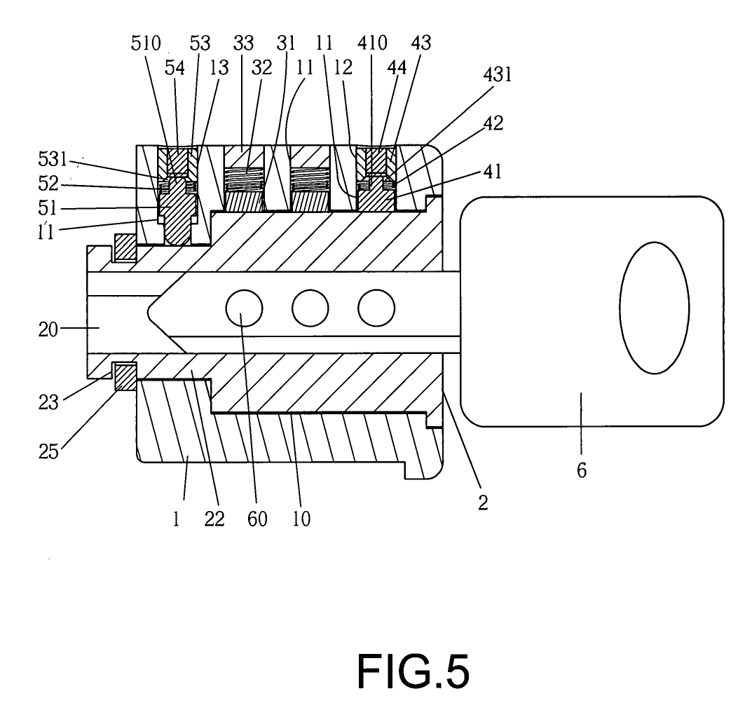

In using, as shown in FIG. 3, when the key 6 is not yet inserted in the key hole 20, the locking pin units 3, the alarm actuating unit 4 and the alarm stopping unit 5 have the long pins 30 and 40, the short pins 31 and 41 and the pin 51 are elastically maintained by the springs 32, 42 and 52. Meanwhile, the long pins 30 and 40 of the locking pin units 3 and the alarm actuating unit 4 all have their lower ends extending in the key hole 20 of the inner rotary member 2, and the short pins 31 and 41 of the locking pin units 3 and the alarm actuating unit 4 are located partly both in the shell 1 and the inner rotary member 2, keeping the inner rotary member 2 from rotated. In case that the lock with this lock core is to be unlocked, the key 6 is inserted in the key hole 20 of the inner rotary member 2 as shown in FIG. 4, letting the surface of the key 6 facing and pushing up the bottoms of the long pins 40 and 30 and the short pins 41 and 31 of the alarm actuating unit 4 and the locking pin units 3, compressing the springs 42 and 32, moving the short pins 41 and 31 completely into the holes 11 of the shell 1. Then the connecting surfaces of the long pins 30 and 40 and the short pins 31 and 41 are aligned with the connecting surfaces of the shell 1 and the inner rotary member 2, permitting the inner rotary member 2 rotate, with the pin 41 of the alarm actuating unit 4 pushed up. Then the stud 410 of the pin 41 extends in the hole 431 of the insulating base 43 to touch the trigger switch 44 to electrify the alarm in the lock, which then sounds out. If the user then rotates the key 6 to make the inner rotary member 2 rotate for a certain angle, as shown in FIG. 5, the outer surface of the projecting member 22 of the inner rotary member 2 pushes up the pin 51 of the alarm stopping unit 5, compressing the spring 52, pushing up the pin 51 with the stud 510 extending through the hole 531 of the insulating base 53 to touch the stopping switch 54 to turn off the alarm immediately. In this way, the lock is also unlocked at the same time. The alarm is set to sound out in case stopping action is not carried out within 3 to 5 seconds.

Therefore, if a thief tries to pry open the lock with the lock core of the present invention by inserting a wrong key or any tool in the key hole 20 of the inner rotary member 2, the surface of the wrong key or some tool may push up the long pin 40 of the alarm actuating unit 4, and then the short pin 41 to move up the stud 410 of the short pin 41, which then extends up to touch the trigger switch 44 to turn on the alarm in the preset time limit. Thus if he thief could not rotate the wrong key or the like to rotate the inner rotary member 2 within the preset time limit, then the alarm will sound out to frighten the thief without fail. Then other persons near the lock may pay attention to the sound to look around to know what is the matter. Thus the thief may run away from the lock quickly, very afraid to keep on prying open the lock.

While the embodiment of the invention has been described above, it will be recognized and understood that various modifications may be made therein and the appended claims are intended to cover all such modifications that may fall within the spirit and scope of the invention.

1. A lock core with an alarm comprising:
a shell provided with a center chamber, a plurality of transverse holes spaced apart in a straight line in the wall of said shell, and a groove formed respectively in an upper end of a foremost and a rearmost one of said transverse holes;
an inner rotary member received movable in said chamber of said shell, said inner rotary member having a key hole, a plurality of transverse holes spaced apart in a straight line in the wall of said inner rotary member, said transverse holes corresponding to said transverse holes of said shell, a projecting member formed to extend rearward from the inner rotary member and having an annular groove and a recess formed on an outer surface of said projecting member, a hook ring engaging with said annular groove;
a plurality of locking pin units respectively received in said transverse holes of said shell and of said inner rotary member;
an alarm actuating unit received in said foremost transverse holes of said shell and of said inner rotary member as well, said alarm actuating unit consisting of a long pin, a short pin, a spring, an insulating base and a trigger switch orderly arranged; and,
an alarm-stopping unit received in said rearmost transverse hole of said shell and in said recess of said inner rotary member, said alarm-stopping unit consisting of a pin, a spring, an insulating base and a stopping switch.

2. The lock core with an alarm as claimed in claim 1, wherein said lock pin unit consists of a long pin, a short pin, a spring and a stopper.

3. The lock core with an alarm as claimed in claim 1, wherein said pin of said alarm actuating unit has a stud on its upper end, said insulating base has a cell opening upward and a hole in its bottom, said trigger switch deposited in said cell and having a conductive member connected with an alarm provided in a lock with said lock core.

4. The lock core with an alarm as claimed in claim 1, wherein said pin of said alarm stopping unit has a stud on its upper end, said insulating base has a cell and a hole in its bottom, said stopping switch deposited in said cell and having an conductive member connected with said alarm in said lock.
